(19) United States
(12) Patent Application Publication
(10) Pub. No.: US 2015/0187095 A1
(43) Pub. Date: Jul. 2, 2015

(54) METHOD AND DEVICE FOR IMPLEMENTING PAGE MASK

(71) Applicant: Tencent Technology (Shenzhen) Company Limited, Shenzhen City (CN)

(72) Inventors: Qi ZOU, Shenzhen City (CN); Rong LI, Shenzhen City (CN)

(21) Appl. No.: 14/641,108

(22) Filed: Mar. 6, 2015

Related U.S. Application Data
(63) Continuation of application No. PCT/CN2013/082849, filed on Sep. 3, 2013.

(30) Foreign Application Priority Data
Sep. 7, 2012 (CN) 201210330093.5

(51) Int. Cl. G06T 11/00; G06T 11/60

(52) U.S. Cl. CPC G06T 11/001; G06T 11/60

(57) ABSTRACT

The method comprises: acquiring page information about a page of which a mask needs to be displayed; the page information comprising: the height and width of the page of which the mask needs to be displayed, and a location area in the page of at least one page element which needs to be hollowly displayed by the mask; and according to the page information, drawing a corresponding hollow mask on the page, so as to display the page element by means of the hollow location on the mask.

### CROSS-REFERENCE TO RELATED APPLICATIONS

This application is a continuation of International Application No. PCT/CN2013/082849, filed on Sep. 3, 2013. This application claims the benefit and priority of Chinese Patent Application No. 201210330093.5, filed Sep. 7, 2012. The entire disclosures of each of the above applications are incorporated herein by reference.

### FIELD OF THE DISCLOSURE

The present disclosure relates to mobile terminal techniques, and more particularly, to a method and an apparatus for masking a page.

### BACKGROUND OF THE DISCLOSURE

A masked page is a page on which a mask is applied. It mainly used for attracting user's attentions to contents displayed over the mask. Masks are widely used and one usage is to guide users to a particular page element displayed on the page.

For example, a new function is configured on a page. Geographic location of the user may be displayed when cursor is moved to avatar of the user. It is a problem how to guide the user to notice this new function.

### SUMMARY OF THE DISCLOSURE

Examples of the present disclosure provide a method and an apparatus for masking a page. The technical solution is as follows.

According to an example of the present disclosure, a method for masking a page includes:
obtaining page information of a page to be masked;
wherein the page information comprises height and width of the page to be masked, and a location of at least one page element in the page visible through an opening area or a transparent area of the mask; and
creating the mask with the opening area or the transparent area and masking the page according to the page information, wherein after the page is masked, the at least one page element is visible through the opening area or the transparent area.

According to another example of the present disclosure, an apparatus for masking a page includes:
an obtaining module, to obtain page information of the page to be covered with the mask; the page having at least one page element that is visible after the page is covered with the mask;
wherein the page information comprises height and width of the page, and a location of the at least one page element in the page; and
a creating module, to create a canvas with an opening area or a transparent area according to the page information, mask the page using the canvas as the mask, wherein after the page is covered with the mask, the at least one page element is visible through the opening area or the transparent area of the mask.

According to still another example of the present disclosure, an apparatus for masking a page includes: a processor and a memory; wherein the memory stores machine readable instructions to be executed by the processor to perform acts of:
obtaining page information of a page to be masked;
wherein the page information comprises height and width of the page to be masked, and a location of at least one page element in the page visible through an opening area or a transparent area of the mask; and
creating the mask with the opening area or the transparent area and masking the page according to the page information, wherein after the page is masked, the at least one page element is visible through the opening area or the transparent area.

In this example, the page information of the page to be masked is obtained first. The page information includes height and width of the page and a location of at least one page element visible through an opening area or a transparent area of the mask. A mask with the opening area or the transparent area is created and used to mask the page according to the page information, such that the page element is visible through the opening area or the transparent area of the mask. It is not required to copy the page element. The page element is visible through the opening area or the transparent area of the mask, which reduces maintenance work loads.

### BRIEF DESCRIPTION OF THE DRAWINGS

Drawings used in the descriptions of the examples of the present disclosure are briefly introduced hereinafter to make the technical solution of the present disclosure clearer. It should be noted that, the following drawings are just some examples. For those skilled in the art, many variations are possible based on the following drawings without any inventive work.

FIG. 1 shows an example of a method for masking a page according to the present disclosure.

FIG. 2 shows another example of a method for masking a page according to the present disclosure.

FIG. 3 shows an example of a mask of a page according to the present disclosure.

FIG. 4 shows still another example of a method for masking a page according to the present disclosure.

FIG. 5 shows an example of an apparatus for masking a page according to the present disclosure.

FIG. 6 shows another example of an apparatus for masking a page according to the present disclosure.

FIG. 7 shows yet another example of an apparatus for masking a page according to the present disclosure.

FIG. 8 shows still another example of an apparatus for masking a page according to the present disclosure.

### DETAILED DESCRIPTION OF THE DISCLOSURE

The present disclosure is described in further detail hereinafter with reference to accompanying drawings and examples to make the technical solution and merits therein clearer.

In a method for masking a page, a mask covering a whole page is drawn taking the page as a background. Then the mask is taken as a background, a copy of a page element which needs to be displayed through the mask is drawn over the mask according to a location of the page element in the page, such that the copy of the page element is displayed over the mask.

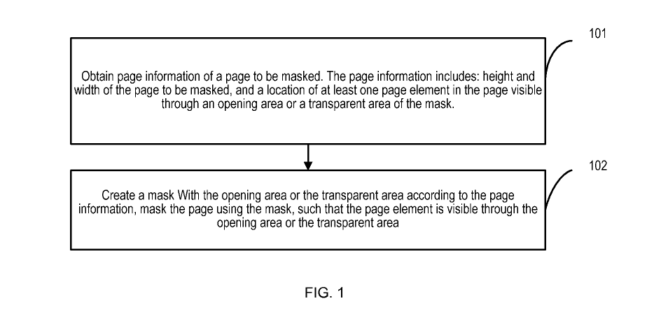

An example of the present disclosure provides a method for masking a page. As shown in FIG. 1, the method includes the following.

At block 101, page information of a page to be masked is obtained.

The page information includes: height and width of the page to be masked, and a location of at least one page element in the page visible via an opening area or a transparent area of the mask.

At block 102, a mask with an opening area or a transparent area is created and used to mask the page according to the page information, such that the page element is visible through the opening area or the transparent area of the mask.

In this example, the page information of the page to be masked is obtained first. The page information includes height and width of the page and a location of at least one page element which is visible via the opening area or the transparent area of the mask. A mask with the opening area or the transparent area is created and used to mask the page according to the page information, such that the page element is visible through the opening area or the transparent area of the mask. It is not required to copy the page element. The page element is visible through the opening area or the transparent area of the mask, which reduces maintenance work loads.

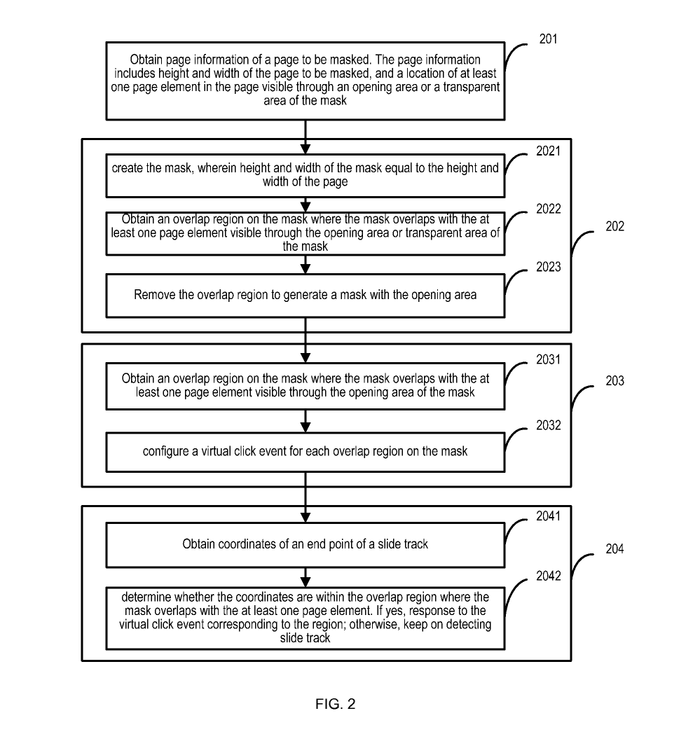

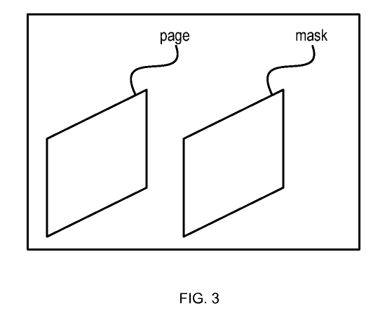

Another example of the present disclosure provides a method for masking a page. As shown in FIG. 2 and FIG. 3, the method includes the following.

At block 201, page information of a page to be masked is obtained.

The page information includes height and width of the page to be masked, and a location of at least one page element in the page visible through an opening area or a transparent area of the mask.

The page to be masked may be any page displayed by a client application (e.g., a browser). Generally, the mask may be applied on a homepage displayed by the client application. In particular, the height and width of the page to be masked may be obtained from page file of the application.

Each page may include several page elements, such as background, title bar, action button, label, icon, etc. According to a requirement, the location of at least one page element visible via an opening area or the transparent area of the mask is obtained. The location may be coordinates of the page element in the page.

At block 202, the mask with the opening area or the transparent area is created and used to mask the page according to the page information, such that the page element is visible through the opening area or the transparent area of the mask.

This block may further include the following.

At block 2021, the mask is created over the page, wherein height and width of the mask equal to the height and width of the page.

The mask covers the page completely. Therefore, the height and width of the mask equal to those of the page. In one example, the mask may be created using a label <canvas> and corresponding script in HTML, or through other techniques. Color and transparency value of the mask are not restricted in the present disclosure. In one example, the transparency value of the mask is not larger than 50%.

At block 2022, an overlap region on the mask where the mask overlaps with the at least one page element visible via the opening area or the transparent area of the mask is obtained.

After the mask is created, the overlap region where the mask overlaps with the at least one page element visible via the opening area or the transparent area of the mask is obtained. In particular, coordinates on the mask having the same values with the coordinates of the page element in the page are obtained. A region surrounded by the coordinates is the overlap region.

At block 2023, the portion of the mask in the overlap region is removed to generate the mask with the opening area, i.e., hollow mask.

After the portion of the mask in the overlap region is determined, the portion of the mask is removed, such that an opening area is formed in the mask. At this time, the page element to be displayed through the mask may be displayed through the opening area in the mask. In particular, the portion of the mask in the overlap region may be removed using a compositing attribute of the label <canvas>. A contour of the overlap region is outlined and then the overlap region is filled with a real color. Thereafter, the compositing attribute of the overlap region filled with the real color is configured to be destination-out, thus a hollow-carved effect is realized.

Herein, although the mask is drawn by vectors using the label <canvas>, it is displayed on a screen in pixels. In order to avoid blur of the mask drawn using the label <canvas> on a high-resolution device, the mask drawn using the label <canvas> may be rendered using a double size and then the label <canvas> is reduced to a half. Thus, a better effect may be realized on the high-resolution device.

At block 203, a virtual click event is configured on the mask.

This block may include the following.

At block 2031, an overlap region on the mask where the mask overlaps with the at least one page element to be displayed via the opening area or the transparent area of the mask is obtained.

This block is similar to block 2022 and is not repeated herein.

At block 2032, a virtual click event is configured for each overlap region on the mask.

The virtual click event is used for man-machine interaction. After the page with the mask is displayed on the screen, users may click the page element visible via the opening area or the transparent area of the mask through touching the screen or other manners. At this time, a response needs to be returned to the user, e.g., a prompt window. Therefore, a virtual click event needs to be configured for the overlap region where the page element is displayed. The virtual click event may be configured according to conventional techniques which are not described herein.

It should be noted that, this block may be performed after block 2022, e.g., between blocks 2022 and 2023.

At block 204, the virtual click event is responded.

This block includes the following.

At block 2041, coordinates of an end point of a slide track are obtained.

After the mask is displayed, slide track of the user on the screen is detected in real time. The slide track includes an end point. The coordinates of the end point are obtained.

At block 2042, it is determined whether the coordinates are within the overlap region where the mask overlaps with the at least one page element visible via the opening area or the transparent area of the mask.

If yes, the virtual click event corresponding to the overlap region is responded; otherwise, keep on detecting the slide track.

When the coordinates are compared with the coordinates of the overlap region, if the coordinates are within the overlap region, the virtual click event corresponding to the overlap region is responded. If the coordinates are not within the overlap region, a next slide track is detected.

In this example, the page information of the page to be masked is obtained first. The page information includes height and width of the page and a location of at least one page element visible through an opening area or a transparent area of the mask. A mask with the opening area or the transparent area is created and used to mask the page according to the page information, such that the page element is visible through the opening area or the transparent area of the mask. It is not required to copy the page element. The page element is visible through the opening area or the transparent area of the mask, which reduces maintenance work loads.

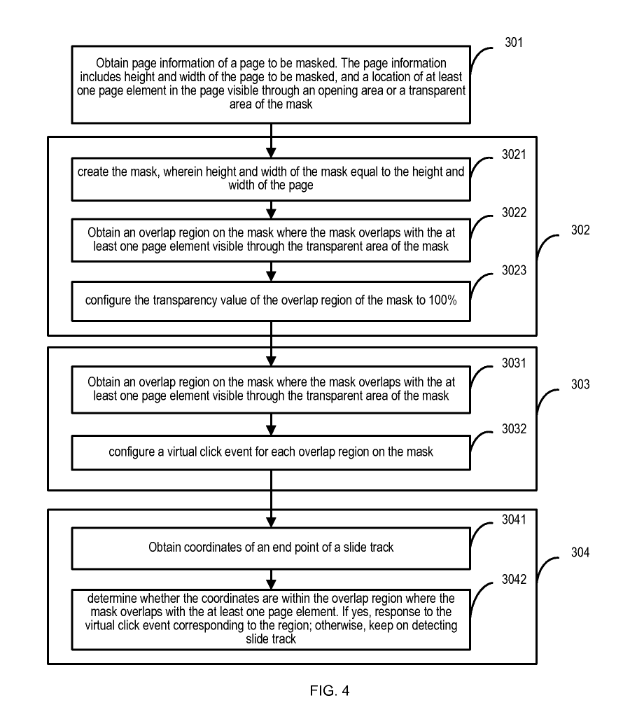

Another example of the present disclosure provides a method for masking a page. As shown in FIG. 4, the method includes the following.

Block 301 is similar to block 201 and is not repeated herein.

At block 302, a mask is created and used to mask the page according to the page information, such that a page element is visible via an opening area or a transparent area of the mask.

This block includes the following.

At block 3021, the mask having the same height and width with the page is drawn over the page.

This block is similar to block 2021 and is not repeated herein.

At block 3022, an overlap region on the mask where the mask overlaps with the at least one page element visible via the opening area or the transparent area of the mask is obtained.

This block is similar to block 2022 and is not repeated herein.

At block 3033, the transparency value of the overlap region of the mask is configured to 100%.

In particular, a border attribute in a <img> label in HTML may be used to configure the transparency of the mask in the overlap region to 100%. The value of the border attribute may be configured to an extremely large value of rgba color. The overlap region is implemented through setting border-radius as 50%. Thus, the overlap region is transparent. The transparent overlap region is a portion of the mask. Thus, an effect that the page element is above the transparent overlap region is generated, which realizes a hollow-carved effect.

Blocks 303˜304 are respectively similar to blocks 203˜204 and are not repeated herein.

In this example, the page information of the page to be masked is obtained first. The page information includes height and width of the page and a location of at least one page element visible through an opening area or a transparent area of the mask. A mask with the transparent area is created and used to mask the page according to the page information, such that the page element is visible through the transparent area of the mask. It is not required to copy the page element. The page element is visible through the transparent area of the mask, which reduces maintenance work loads.

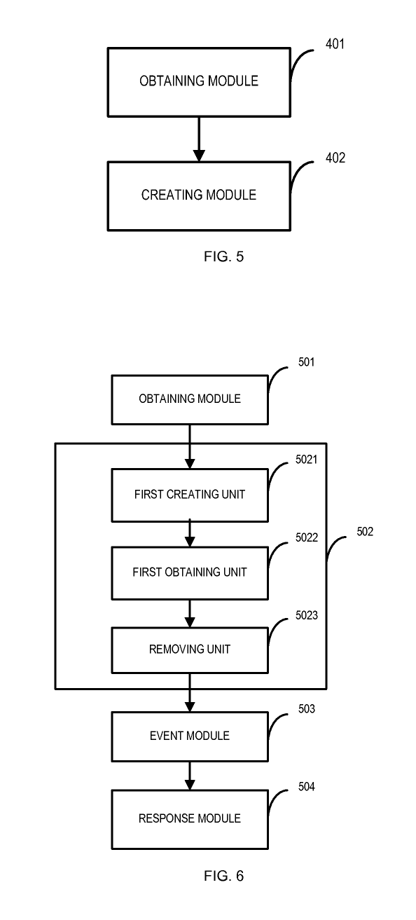

FIG. 5 shows an example of an apparatus for masking a page. As shown in FIG. 5, the apparatus includes:
an obtaining module 401, to obtain page information of a page to be masked;
the page information includes height and width of the page to be masked, and a location of at least one page element in the page which is visible through an opening area or a transparent area of the mask; and
a creating module 402, to create a mask with the opening area or the transparent area according to the page information, mask the page using the mask, such that the at least one page element is visible via the opening area or the transparent area of the mask.

In this example, the page information of the page to be masked is obtained first. The page information includes height and width of the page and a location of at least one page element visible through an opening area or a transparent area of the mask. A mask with the opening area or the transparent area is created and used to mask the page according to the page information, such that the page element is visible through the opening area or the transparent area of the mask. It is not required to copy the page element. The page element is visible through the opening area or the transparent area of the mask, which reduces maintenance work loads.

FIG. 6 shows another example of an apparatus for masking a page. As show in FIG. 6, the apparatus includes the following.
an obtaining module 501, to obtain page information of a page to be masked;
the page information includes height and width of the page to be masked, and a location of at least one page element in the page to be displayed via an opening area or the transparent area of the mask; and
a creating module 502, to create a mask with the opening area or the transparent area over the page according to the page information, and mask the page using the mask, such that the at least one page element is visible via the opening area or the transparent area of the mask.

The creating module 502 includes the following.
a first creating unit 5021, to create a mask which has the same height and width with the page;
a first obtaining unit 5022, to obtain an overlap region where the mask overlaps with the at least one page element visible through the opening area or the transparent area of the mask; and
a removing unit 5023, to remove the overlap region to generate the canvas with the opening area.

The apparatus may further include:
an event module 503, to obtain the overlap region where the mask overlaps with the at least one page element visible via the opening area or the transparent area of the mask, and configure a virtual click event for the overlap region on the mask.

The apparatus may further include:
a response module 504, to obtain coordinates of an end point of a slide track, determine whether the coordinates are within the overlap region; if yes, response to the virtual click event corresponding to the overlap region; otherwise, detect a next slide track.

In this example, the page information of the page to be masked is obtained first. The page information includes height and width of the page and a location of at least one page element visible through an opening area or a transparent area of the mask. A mask with the opening area is created and used to mask the page according to the page information, such that the page element is visible through the opening area of the mask. It is not required to copy the page element. The page element is visible through the opening area of the mask, which reduces maintenance work loads.

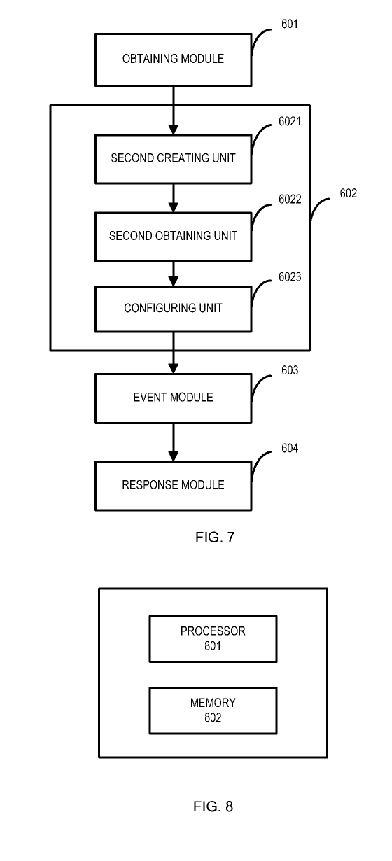

FIG. 7 shows yet another example of an apparatus for masking a page. As shown in FIG. 7, the apparatus includes:
an obtaining module 601, which is similar to the obtaining module 501 and not repeated herein;
a creating module 602, to create a mask with an opening area or a transparent area according to the page information, mask the page using the mask, such that the at least one page element is displayed via the opening area or the transparent area of the mask.

The creating module 602 includes:
a second creating unit 6021, to create a mask which has the same height and width with the page;
a second obtaining unit 6022, to obtain an overlap region where the mask overlaps with the at least one page element which is visible via the opening area or the transparent area of the mask; and
a configuring unit 6023, to configure a transparency value of the overlap region of the mask to 100%.

The apparatus may further include:
an event module 603, which is similar to the event module 503 and is not repeated herein;
a response module 604, which is similar to the response module 504 and is not repeated herein.

In this example, the page information of the page to be masked is obtained first. The page information includes height and width of the page and a location of at least one page element visible through an opening area or a transparent area of the mask. A mask with the transparent area is created and used to mask the page according to the page information, such that the page element is visible through the transparent area of the mask. It is not required to copy the page element. The page element is visible through the transparent area of the mask, which reduces maintenance work loads.

It should be noted that, in the apparatus for masking a page provided by the examples of the present disclosure, descriptions are given taking the above functional modules as examples. In an application, the functions may be implemented by various functional modules according to a requirement, i.e., a device may be divided into various functional modules to accomplish all or some functions as described above. In addition, detailed functions of modules of the apparatus for masking page may be implemented by referring to the description of the method examples and are not repeated herein.

The numerals of the examples are just for facilitating the description but do not represent preference of the examples.

Those skilled in the art would know that some or all blocks of the examples of the present disclosure may be implemented by hardware, or through a program executed on relevant hardware. The program may be stored in a computer readable storage medium. The storage medium may be read-only memory, disk, compact disk, etc.

FIG. 8 shows an example of an apparatus for masking a page. As shown in FIG. 8, the apparatus includes a processor 801 and a memory 802. The memory 802 stores a set of machine-readable instructions to enable the processor 801 to perform acts of:
obtaining page information of a page to be masked;
wherein the page information comprises height and width of the page to be masked, and a location of at least one page element in the page visible through an opening area or a transparent area of the mask; and
creating the mask with the opening area or the transparent area and masking the page according to the page information, wherein after the page is masked, the at least one page element is visible through the opening area or the transparent area.

The memory 802 further stores machine readable instructions to be executed by the processor 801 to perform acts of:
creating the mask having the same height and width with the page over the page;
obtaining an overlap region on the mask where the mask overlaps with the at least one page element visible via the opening area or the transparent area of the mask; and
removing the overlap region to generate the mask with the opening area.

The memory 802 further stores machine readable instructions to be executed by the processor 801 to perform acts of:
creating the mask having the same height and width with the page over the page;
obtaining an overlap region on the mask where the mask overlaps with the at least one page element visible via the opening area or the transparent area of the mask; and
configuring a transparency value of the overlap region to 100%.

The memory 802 further stores machine readable instructions to be executed by the processor 801 to perform acts of:
obtaining an overlap region on the mask where the mask overlaps with the at least one page element to be displayed via the opening area or the transparent area of the mask; and
configuring a virtual click event for the overlap region on the mask.

The memory 802 further stores machine readable instructions to be executed by the processor 801 to perform acts of:
after configuring the virtual click event for the overlap region on the mask, obtaining coordinates of an end point of a slide track;
determining whether the coordinates are within the overlap region;
if the coordinates are within the overlap region, responding to the virtual click event corresponding to the overlap region.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A computer-implemented method for generating a mask covering a page on a screen of a device, wherein the device having a processor and a memory storing machine readable instructions, the method comprising:
obtaining page information of the page, the page having at least one page element that is visible after the page is covered with the mask;
wherein the page information comprises height and width of the page, and a location of the at least one page element on the page;
creating a canvas with an opening area or a transparent area according to the page information, masking the page using the canvas as the mask, wherein after the page is masked, the at least one page element is visible through the opening area or the transparent area.

2. The method of claim 1, wherein the creating the canvas with the opening area or the transparent area according to the page information comprises:
creating a canvas having the same height and width with the page over the page;
obtaining an overlap region on the canvas where the canvas overlaps with the at least one page element visible via the opening area or the transparent area of the canvas; and
removing the overlap region of the canvas to create the canvas with the opening area.

3. The method of claim 1, wherein the creating the canvas with the opening area or the transparent area according to the page information comprises:
creating a canvas having the same height and width with the page over the page;
obtaining an overlap region on the canvas where the canvas overlaps with the at least one page element visible via the opening area or the transparent area of the canvas; and
configuring a transparency value of the overlap region to 100%.

4. The method of claim 1, further comprising:
obtaining an overlap region on the canvas where the canvas overlaps with the at least one page element visible via the opening area or the transparent area of the canvas; and
configuring a virtual click event for the overlap region on the canvas.

5. The method of claim 4, further comprising:
after configuring the virtual click event for the overlap region on the canvas, obtaining coordinates of an end point of a slide track;
determining whether the coordinates are within the overlap region;
if the coordinates are within the overlap region, responding to the virtual click event corresponding to the overlap region.

6. An apparatus for generating a mask covering a page on a screen of the apparatus, comprising:
an obtaining module, to obtain page information of the page to be covered with the mask; the page having at least one page element that is visible after the page is covered with the mask;
wherein the page information comprises height and width of the page, and a location of the at least one page element in the page; and
a creating module, to create a canvas with an opening area or a transparent area according to the page information, mask the page using the canvas as the mask, wherein after the page is covered with the mask, the at least one page element is visible through the opening area or the transparent area of the mask.

7. The apparatus of claim 6, wherein the creating module comprises:
a first creating unit, to create a canvas which has the same height and width with the page;
a first obtaining unit, to obtain an overlap region on the canvas where the canvas overlaps with the at least one page element to be displayed via the opening area or the transparent area of the canvas; and
a removing unit, to remove the overlap region to create the canvas with the opening area.

8. The apparatus of claim 6, wherein the creating module comprises:
a second creating unit, to create a canvas which has the same height and width with the page;
a second obtaining unit, to obtain an overlap region on the canvas where the mask overlaps with the at least one page element visible via the opening area or the transparent area of the mask; and
a configuring unit, to configure a transparency value of the overlap region of the canvas to 100%.

9. The method of claim 6, further comprising:
an event module, to obtain the overlap region where the canvas overlaps with the at least one page element visible via the opening area or the transparent area of the mask, and
configure a virtual click event for the overlap region on the canvas.

10. The apparatus of claim 9, further comprising:
a response module, to obtain coordinates of an end point of a slide track,
determine whether the coordinates are within the overlap region;
if yes, response to the virtual click event corresponding to the overlap region; otherwise, detect a next slide track.

11. An apparatus for generating a mask covering a page on a screen of the apparatus, comprising a processor and a memory; wherein the memory stores machine readable instructions to be executed by the processor to perform acts of:
obtaining page information of the page, the page having at least one page element that is visible after the page is covered with the mask;
wherein the page information comprises height and width of the page, and a location of the at least one page element on the page;
creating a canvas with an opening area or a transparent area according to the page information, masking the page using the canvas as the mask, wherein after the page is masked, the at least one page element is visible through the opening area or the transparent area.

12. The apparatus of claim 11, wherein the memory further stores machine readable instructions to be executed by the processor to perform acts of:
creating a canvas having the same height and width with the page over the page;
obtaining an overlap region on the canvas where the canvas overlaps with the at least one page element visible via the opening area or the transparent area of the canvas; and
removing the overlap region to create the canvas with the opening area.

13. The apparatus of claim 11, wherein the memory further stores machine readable instructions to be executed by the processor to perform acts of:
creating a canvas having the same height and width with the page over the page;
obtaining an overlap region on the canvas where the canvas overlaps with the at least one page element visible via the opening area or the transparent area of the canvas; and
configuring a transparency value of the overlap region to 100%.

14. The apparatus of claim 11, wherein the memory further stores machine readable instructions to be executed by the processor to perform acts of:
obtaining an overlap region on the canvas where the canvas overlaps with the at least one page element visible via the opening area or the transparent area of the canvas; and
configuring a virtual click event for the overlap region on the canvas.

15. The apparatus of claim 14, wherein the memory further stores machine readable instructions to be executed by the processor to perform acts of:
after configuring the virtual click event for the overlap region on the canvas, obtaining coordinates of an end point of a slide track;
determining whether the coordinates are within the overlap region;
if the coordinates are within the overlap region, responding to the virtual click event corresponding to the overlap region.
